(19) United States
(12) Patent Application Publication
(10) Pub. No.: US 2025/0010655 A1
(43) Pub. Date: Jan. 9, 2025

(54) APPARATUSES AND METHODS FOR MAKING 3D STICKERS, 3D CARDS, JEWELRY AND BUTTONS

(71) Applicant: WeCool Toys Inc., Point Pleasant, NJ (US)

(72) Inventor: Jeffrey Osnato, Medford, NJ (US)

(21) Appl. No.: 18/763,496

(22) Filed: Jul. 3, 2024

Related U.S. Application Data
(63) Continuation of application No. 29/879,442, filed on Jul. 7, 2023.
(60) Provisional application No. 63/589,782, filed on Oct. 12, 2023.
(60) Provisional application No. 63/512,298, filed on Jul. 7, 2023.

(51) Int. Cl. B44C 3/12; B42D 15/04

(52) U.S. Cl. CPC B44C 3/12; B42D 15/045

(57) ABSTRACT

Kids can create a new dimension of fun with 3D stickers using a 3D sticker maker. The 3D stickers can be personalized with sprinkles, glitter, and gem mix-ins! The 3D stickers can be used to decorate notebooks, journals, and cards. The 3D stickers can be shared with friends. Kits incorporating the 3D sticker maker can further include thirty (30) sticker blisters, thirty (30) sticker backgrounds, thirty (30) double-sided sticker adhesives, one (1) sprinkle packet, two (2) glitter packets, two hundred and fifty gems (250) gems, and instructions for using the 3D sticker maker and other components included in the kit.

### CROSS REFERENCE TO RELATED APPLICATIONS

This application claims priority under 35 U.S.C. § 119 to provisional patent application 63/512,298, titled “APPARATUS FOR MAKING 3D STICKERS, JEWELRY AND BUTTONS”, filed Jul. 7, 2023; and to provisional patent application 63/589,782, titled “APPARATUS FOR MAKING 3D CARDS”, filed Oct. 12, 2023. This application further claims priority under 35 U.S.C. § 120 to U.S. Ser. No. 29/879,442, titled “3D STICKER MAKER”, filed Jul. 7, 2023. Each of the prior provisional patent applications and design patent application are hereby incorporated by reference in their entireties herein, including without limitation: the specification, claims, and abstract, as well as any figures, tables, appendices, or drawings thereof.

### TECHNICAL FIELD

The present invention relates generally to an apparatus for making 3D stickers, 3D cards, jewelry, and buttons.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Children love toys, games, and activities. For children, toys, games, and activities are more than just fun. Most provide at least some opportunity for children to learn. The best toys engage the senses and spark imaginations. The best activities encourage children to interact with others and teach teamwork.

From a very early age, children are eager to learn more about the world around them. Every new shape, color, texture, taste, and sound presents an opportunity to learn more. Parents quickly identify giving their children toys that are safe and stimulating will help their children discover their senses. Rattles and toys that make music are favorites of infants. Toys with contrasting colors are fascinating to babies and stimulate their developing vision. As they grow, infants can use toys to explore object permanence and cause and effect relationships. They also need objects such as blocks to help them build motor skills and hand-eye coordination.

Toddlers can play with a wider variety of toys than infants. Toddlers may still enjoy some of the toys they played with as babies, however they also need that are designed with their increased capability to learn in mind. Even the same blocks they played with previously can provide them with new and different educational opportunities as their knowledge expands. Shape sorters are great for toddlers. They teach them how to match similar items and provide parents the opportunity to teach them the names of the shapes. Lego® blocks, for example, provide an opportunity to learn more about colors and symmetry developing a child's motor skills.

When children reach schooling age, parents and teachers shift their focus from helping children discover their senses to developing a child's aptitude for lingual (e.g., written and spoken), numeric, memorial, and social skills. There are a lot of toys that encourage this type of learning, from simple alphabet puzzles to high-tech electronic gadgets. These toys help give children a head start by introducing them to the things they will be learning in school. Kids who are in school can supplement their learning with recreational and educational toys. Giving children the opportunity to have fun while practicing the things they are learning in school will increase their retention of those things.

Children often make an emotional connection with their toys. Not surprisingly, the value a child assigns to any given collection is not monetary but sentimental. Thus, some connections are stronger than others. The collections allow children to relive previous experiences and connect themselves to a period or to a time they feel strongly about. This in effect helps case insecurity and anxiety and allows the past to continue to exist in the present.

It is often a challenge for creators of games and activities to garner the attention of a child while still creating a strong emotional connection thereto. Often times, solutions in the art rely solely on the use of screen-time. Think video games, phone apps, and the like. It is however known children who spend too much time with screen-time activities score lower on language and thinking tests, and in extreme cases, screen-time can cause thinning of the brain's cortex, the area of the brain related to critical thinking and reasoning. It is thus essential that children remain engaged in outdoor activities, such as playing with toys to foster imagination and creativity, exploring, and playing with other children to develop appropriate social skills.

Thus, there exists a need in the art for more toys which garner the attention of a child while still creating a strong emotional connection thereto, without having to resort to increasing screen time.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide children with the ability to make customizable 3D stickers and cards.

It is still yet a further object, feature, and/or advantage of the present disclosure to allow intuitive use of a 3D sticker maker and/or a 3D card maker. In some embodiments, the 3D sticker maker can also be a 3D card maker.

It is still yet a further object, feature, or advantage of the present invention to provide a toy which can be used by children of different skillsets and skill levels. For example, some models can be provided which require the child to initially assemble the 3D sticker maker and/or the 3D card maker according to instructions provided therewith. Such assembly can allow for customization of the 3D sticker maker/3D card maker, such as where removable and distinct aesthetic features that attach to the outside of the device can be customized according to the child's preferences.

It is still yet a further object, feature, or advantage of the present invention to provide a child the ability to engage in an activity which can be practiced along and/or while playing with other children. For example, a means for engaging social media may be provided with the 3D sticker maker and/or the 3D card maker.

It is still yet a further object, feature, or advantage of the present invention to provide a 3D sticker maker and/or 3D card maker that may be played with in a wide variety of applications. For example, children can collect different shapes and sized of 3D stickers and/or 3D cards, play with individual components of the 3D stickers (e.g., glitter, beads, etc.) and/or 3D cards, or arrange components of the 3D sticker maker and/or 3D card maker and the associated kit for easy storage until later play. The diversity of 3D stickers and 3D cards is evident in their applications. For instance, 3D stickers can be placed on shoes and can even help provide a cushioning layer. For other potential applications, 3D stickers can be are tailored for product packaging.

It is still yet a further object, feature, or advantage of the present invention to enhance play with other toys using the 3D stickers and/or 3D cards.

It is still yet a further object, feature, or advantage of the present invention to add mix-ins, sprinkles, glitter, foils, and gems to the 3D stickers and/or 3D cards.

It is still yet a further object, feature, or advantage of the present invention to select blister stickers with an appropriate level of adhesion, the material's compatibility with the product, and the environmental conditions the sticker will be exposed to.

It is still yet a further object, feature, or advantage of the present invention to allow for the customizable design of stickers and cards to ensure that the stickers align with the end user's preferences.

It is still yet a further object, feature, or advantage of the present invention to offer 3D stickers and 3D cards that have a protective seal against contaminants.

It is still yet a further object, feature, or advantage of the present invention to provides stickers and cards with clear and vibrant print quality.

It is still yet a further object, feature, or advantage of the present invention to provide 3D stickers and 3D cards that are comfortable in tactile terms. End users should be encouraged to interact with the 3D stickers and 3D cards protected from unwanted friction, showcasing the functional benefits of these stickers beyond mere aesthetics.

It is still yet a further object, feature, or advantage of the present invention to emphasize sustainability. 3D cards and 3D stickers can be constructed from eco-friendly materials. These sustainable choices help businesses align with environmental standards and appeal to a consumer base that values green initiatives.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of 3D sticker maker and/or 3D card maker.

Methods can be practiced which facilitate use, manufacture, assembly, maintenance, and repair of a 3D sticker maker and/or 3D card maker which accomplish some or all of the previously stated objectives. For example, a method of use can comprise setting a first side of a sticker into the 3D sticker making, loading a cavity of said first side of the 3D sticker with added mix-ins, sprinkles, glitter, foils, and/or gems, enclosing the cavity with a second side of the 3D sticker such that portions of the first side and the second side adhere to one another, pressing a button on the 3D sticker maker to cut the first side and the second side of the 3D sticker into a desired shape. Optionally the methods of use can comprise sticking the 3D sticker to another object. In yet another example, a method for making a 3D card can comprise placing a blister background into a blister that is then loaded into a blister hole of a 3D card comprising distinct sides, wherein said 3D card is held in place by a 3D card holder; putting the assembled combination into a 3D card maker; pressing a button on the 3D card maker to seal the blister background into the 3D card. The method can further comprise folding the 3D card and/or further loading the blister with added mix-ins, sprinkles, glitter, foils, and/or gems;

The 3D sticker maker can be incorporated into systems and kits which accomplish some or all of the previously stated objectives. A non-limiting example of a kit includes a 3D sticker maker, thirty (30) sticker blisters, thirty (30) sticker backgrounds, thirty (30) double-sided sticker adhesives, one (1) sprinkle packet, two (2) glitter packets, two hundred and fifty gems (250) gems, and instructions for using the 3D sticker maker and other components included in the kit. A non-limiting example of a system for making a 3D card comprises a 3D card maker, a card holder, foldable cards comprising a blister hole, a blister background comprising distinct sides, and a blister that can fit into the blister hole. Optionally, the system can include a packet selected from the group consisting of: a sprinkle packet and a glitter packet and/or gems. Preferably, the instructions are easy-to-follow instructions, making it simple for kids to create their own 3D stickers. The instructions still encourage artistic expression and fine motor skills in a fun and engaging way.

According to some aspects the 3D sticker/card maker can comprise a top portion hingedly connected to a bottom portion, a mechanically actuated button that passes through the top portion and can be pressed at an elevation above a top surface of the top portion; support structure(s) that allow for components of the 3D sticker/card to be assembled within the 3D sticker/card maker; and an output in the bottom portion through which transports 3D stickers/cards that are created as a result of pressing the mechanically actuated button from within the 3D sticker/card maker to outside the 3D sticker/card maker. The 3D sticker/card maker can further comprise a base with a bottom wall that allows the 3D sticker/card to stand upright when laid flat on a flat surface.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a front perspective view of a 3D sticker maker.

FIG. 2 shows a top perspective view of the 3D sticker maker of FIG. 1.

FIG. 3 shows a bottom perspective view of the 3D sticker maker of FIG. 1.

FIG. 4 shows a rear perspective view of the 3D sticker maker of FIG. 1.

FIG. 5 shows a front elevation view of the 3D sticker maker of FIG. 1.

FIG. 6 shows a rear elevation view of the 3D sticker maker of FIG. 1.

FIG. 7 shows is a left-side elevation view of the 3D sticker maker of FIG. 1.

FIG. 8 shows a right-side elevation view of the 3D sticker maker of FIG. 1.

FIG. 9 shows a top plan view of the 3D sticker maker of FIG. 1.

FIG. 10 shows a bottom plan view of the 3D sticker maker of FIG. 1.

FIG. 11 shows an exploded view of the 3D sticker maker of FIG. 1.

FIG. 12 shows a top cross-sectional view of the 3D sticker maker of FIG. 1.

FIG. 13 shows a rear cross-sectional view of the 3D sticker maker of FIG. 1.

FIG. 14 shows a right-side cross-sectional view of the 3D sticker maker of FIG. 1.

FIG. 15A shows a front perspective view of a 3D card maker in a closed position.

FIG. 15B shows a top perspective view of the 3D card maker of FIG. 15A in an open position.

FIG. 15C shows a front elevation view of the 3D card maker of FIG. 15A in a closed position.

FIG. 15D shows a rear elevation view of the 3D card maker of FIG. 15A.

FIG. 15E shows a disassembled perspective view of the 3D card maker of FIG. 15A.

FIG. 16A shows is a front elevation view of the 3D card maker of FIG. 15A, emphasizing some potential dimensions for same, according to some embodiments.

FIG. 16B shows a top plan view of the 3D card maker of FIG. 15A, emphasizing some potential dimensions for same, according to some embodiments.

FIG. 16C shows a bottom plan view of the 3D card maker of FIG. 15A, emphasizing some potential dimensions for same, according to some embodiments. FIG. 16C also shows how to orient the 3D card within the 3D card maker of FIG. 15A.

FIG. 17A shows a front elevation view of a 3D card assembly usable with the 3D card maker of FIG. 15A.

FIG. 17B shows a front elevation view of the 3D card assembly of FIG. 17A.

FIG. 18 charts a process for creating a 3D card.

FIG. 19A shows a front elevational view of artwork for the blister background usable with the 3D card maker, emphasizing some potential dimensions for same, according to some embodiments.

FIG. 19B shows a front elevational view of artwork for the blister background usable with the 3D card maker, emphasizing some potential colors for same, according to some embodiments.

FIG. 20A shows a planar view of artwork included on inside of the 3D card, emphasizing some potential colors for same, according to some embodiments.

FIG. 20B shows a planar view of artwork included on outside of the 3D card, emphasizing some potential colors for same, according to some embodiments.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

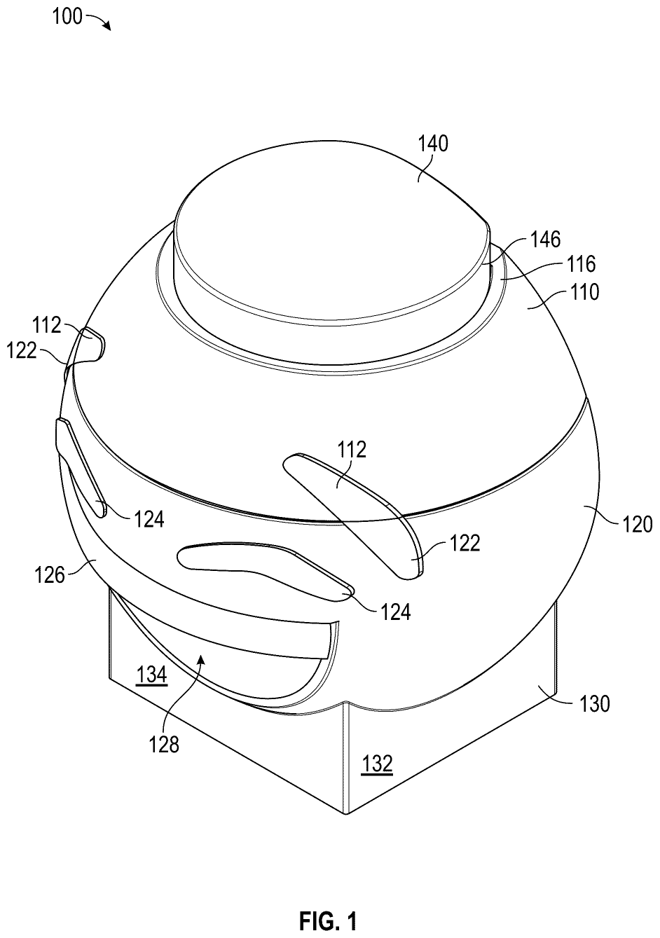

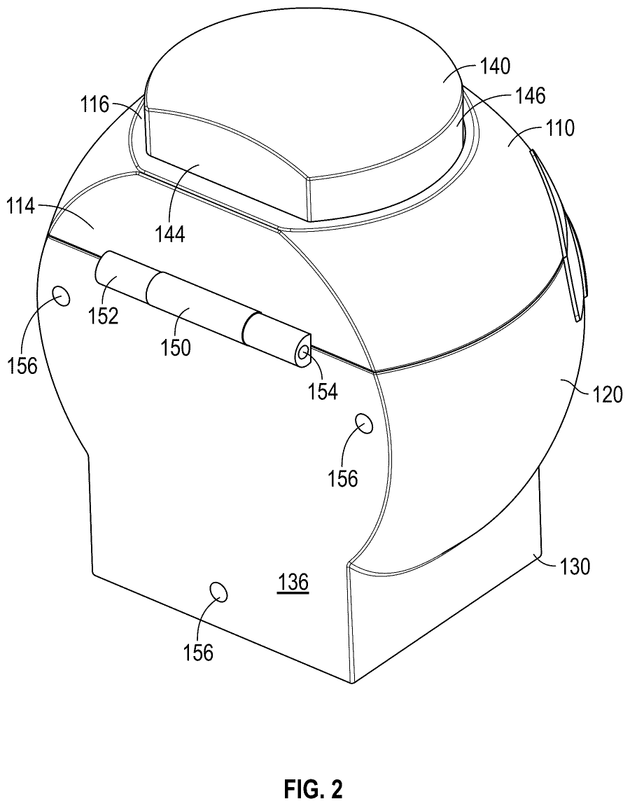

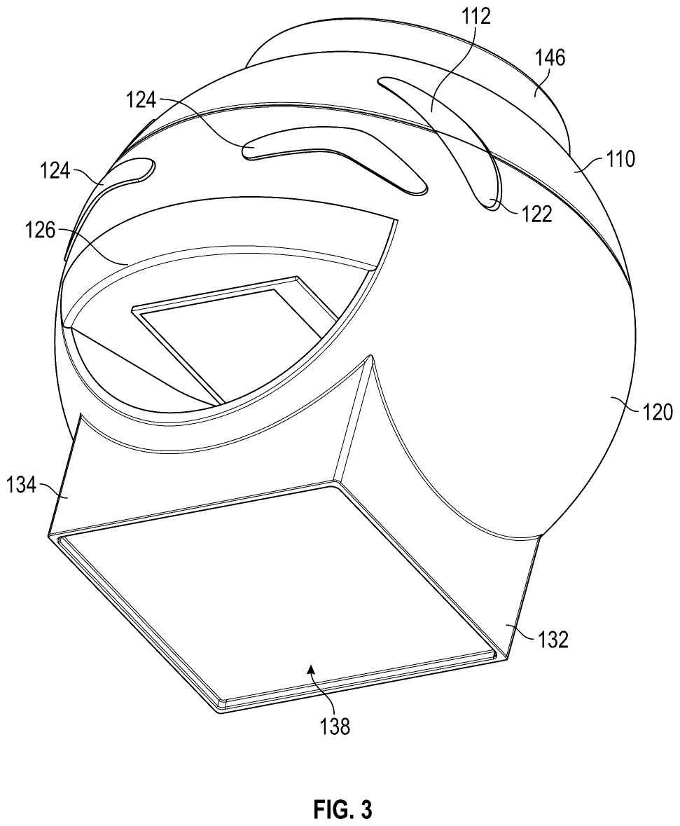

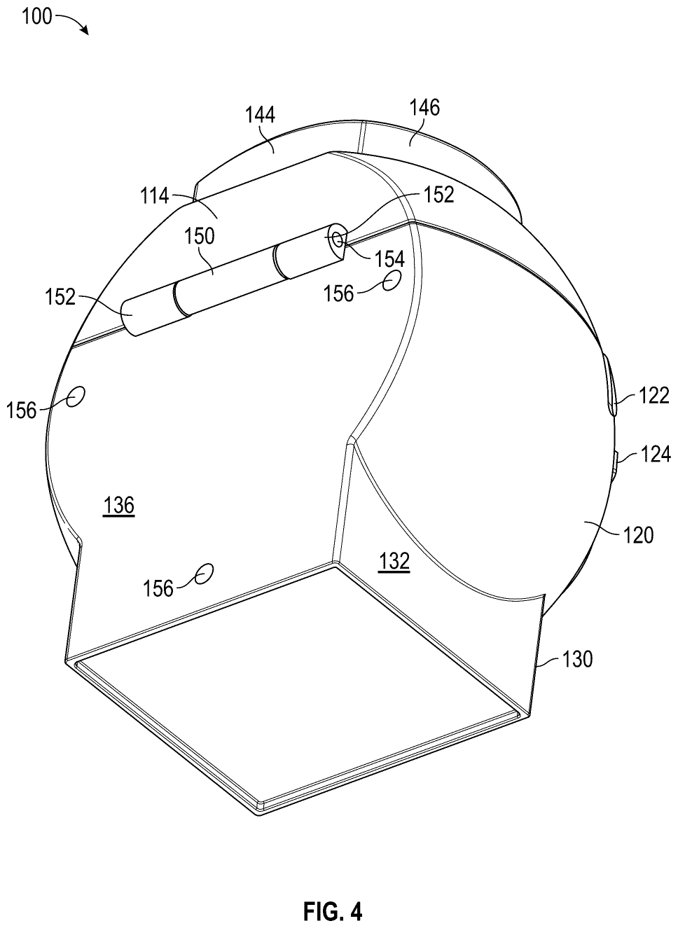

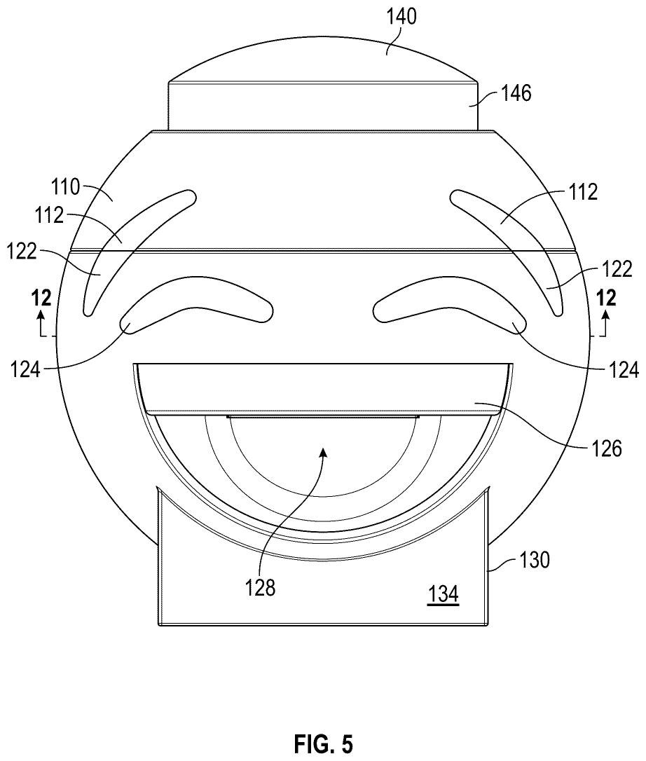

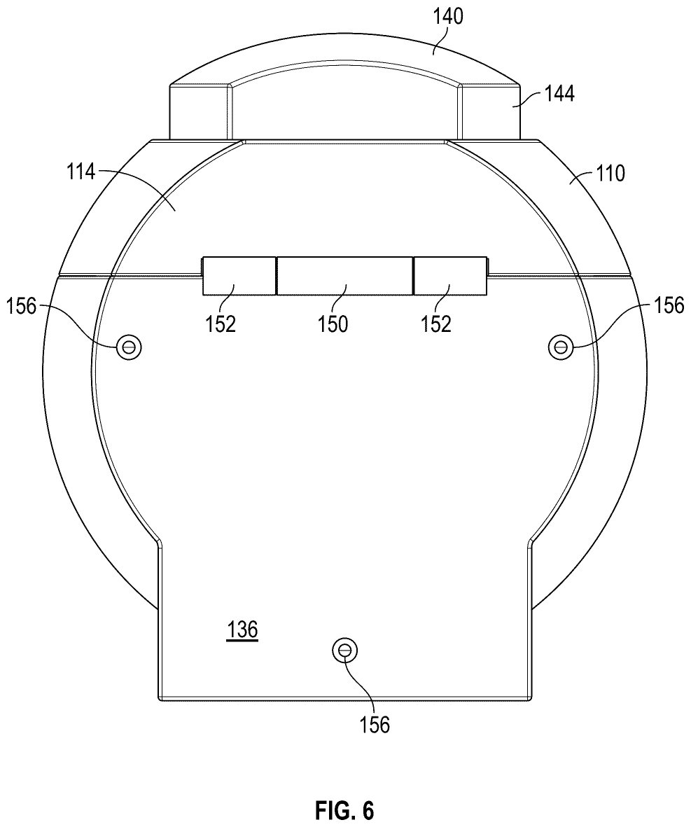

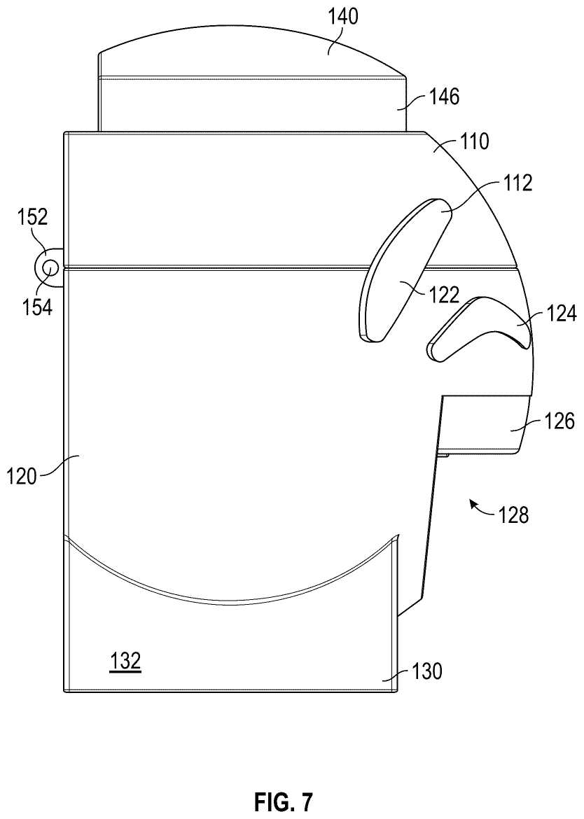

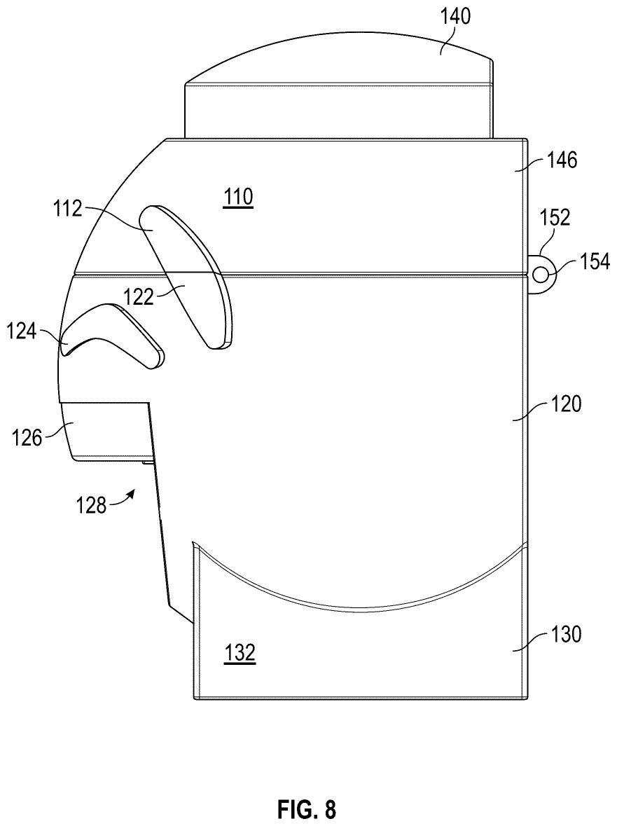

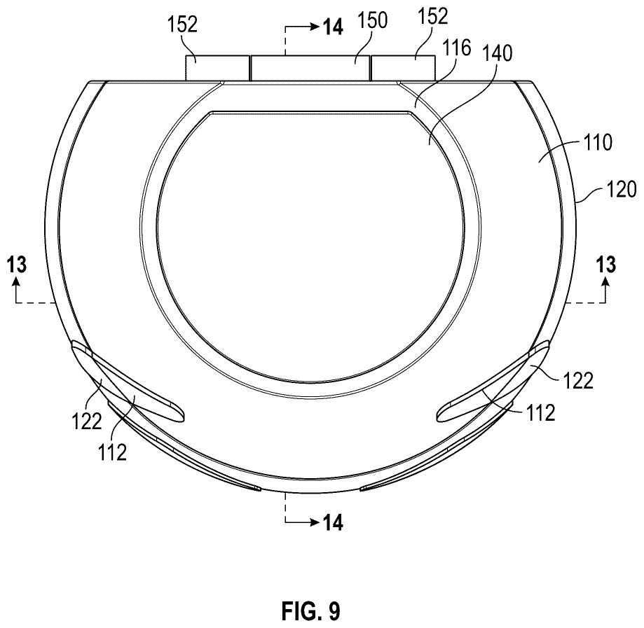

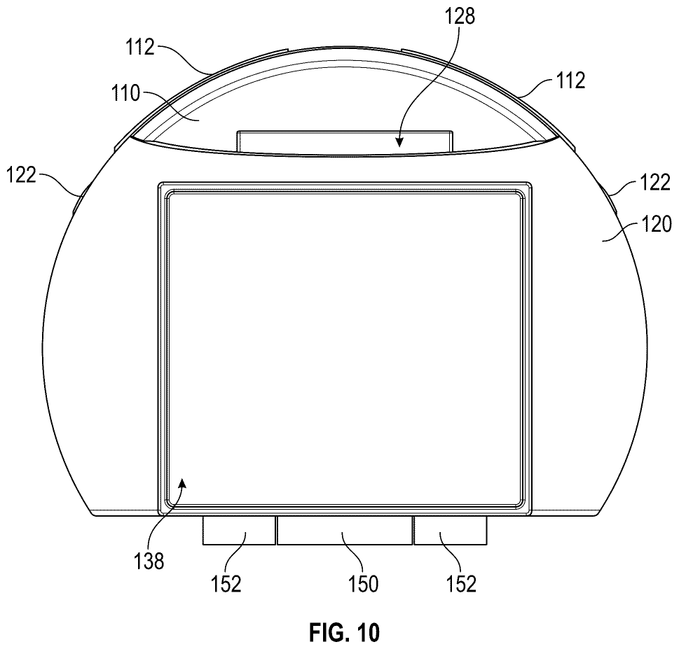

FIGS. 1-14 show details of a 3D sticker maker 100. The 3D sticker maker 100 comprises a top portion 110, a bottom portion 120, a base 130, a button 140, and a hinge (components 150-154). The top portion 110 and the bottom portion 120 are attached by the hinge. The bottom portion 120 and the base 130 are either directly attached to one another or form one integral piece. The button 140 is slidably connected to the top portion 110.

The top portion 110 includes first aesthetic features 112, and the bottom portion 120 includes a second aesthetic features 122. As shown in the non-limiting example of FIGS. 1-14, the first aesthetic features 112 depicts an upper portion of an eyebrow, while the second aesthetic features 122 depict a lower portion of an eyebrow. The aesthetic features 112, 122 are designed help improve the overlook look of the 3D sticker maker 100, to create unique and distinct looks while the 3D sticker maker 100 is in an open position versus while the 3D sticker maker 100 is in a closed position. Additionally, the aesthetic features 112, 122 can be dual-purpose in that they can also suggest proper alignment of the top portion 110 and bottom portion 120 while the 3D sticker maker 100 is in the closed position.

The aesthetic features 112, 122 are shown to be stationary features permanently attached in place to the top portion 110 and bottom portion 120, respectively. However, it is to be appreciated that aesthetic features 112, 122 may be rotatable, translatable, removable, or any combination thereof. The top portion 110 and bottom portion 120 can be configured with several potential mounting points for the aesthetic features 112, 122, to allow the 3D sticker maker 100 a more customizable look. Not all of the mounting points would have to be utilized at once.

The present disclosure is not limited to just one set of aesthetic features 112, 122 for each of the top and bottom portions 110, 120, respectively. One or more distinct concepts for aesthetic features can be utilized on the top portion 110, the bottom portion 120, or for both portions 110, 120.

For example, in the embodiment shown in FIGS. 1-14, the top portion 110 includes only the aesthetic features 112, while the bottom portion includes the aesthetic features 122, 124, and 126. As mentioned previously, the top and bottom portions 110, 120 depict portions of eyebrows that can help determine proper alignment amongst same. The bottom portion 120 also includes the aesthetic features 124, 126, which depict eyes and teeth, respectively.

As shown in FIGS. 1-14, the top portion 110 includes a rear surface 114. The top portion 110 is analogous to the crown of the head, and the rear surface 114 is analogous to the occiput. The top portion 110 also includes a top surface 116, which in this instance is an annular flange, near where the top portion 110 is in slidable connection with the button 140.

The bottom portion 120 includes an output channel 128 for a 3D sticker. The output channel 128 is depicted as an open mouth.

Kits that include the 3D stickers can include over fifty (50) custom refills to create a wide variety of vibrant 3D stickers, perfect for parties and playdates. Specifically, fifty (50) separate sets of sticker blisters, backgrounds, and blister trays, plus sprinkles and glitter mix-ins can be included in a single, supplemental kit or they can be included in an initial kit that includes the 3D sticker maker 100. The kits can be themed, such as an undersea theme or a safari theme.

The base 130 takes the shape of a rectangular prism with side walls 132, a front wall 134, a rear wall 136, and a bottom wall 138. The base 130 is designed so that the 3D sticker maker 100 can stand upright while the bottom wall 138 rests on a flat surface, such as a table or a desk. The base 130 has a center of gravity that is located near or right below the center of gravity of the top and bottom portions 110, 120. This allows the base 130 to support the weight of the 3D sticker maker 100 without risk of tipping or toppling. The side walls 132 of the base 130 are located more inwardly than the outwardmost locations of the top and bottom portions 110, 120. The front wall 134 is located behind the output channel 128. The rear wall 136 is shown to be flush with the rear surface 114 of the top portion 110 when the 3D sticker maker 100 is in a closed position.

The button 140 includes a mechanically actuated member 142, which in this instance is a cylindrical shaft. The mechanically actuated member 142 can be actuated through force mechanically applied to the top of the button 140, such as by the push of the human hand, and actuated again through force applied by a biasing mechanism 148, which in this instance is a resilient spring. The button 140 is shaped with a flat, rear surface 144, located more inwardly than the rear surface and wall 114, 136 of the top portion and the base, respectively. A curved surface 146 is approximately concentric with respect to the annular top surface 116 in that the outermost circumference (or, at least, a partial circumference) of the button 140 and inner most circumference (or, at least, a partial circumference) of the top surface 116 are derived from a nearly identical diameter.

As mentioned above, the top portion 110 and the bottom portion 120 establish a hinged connection at the hinge (components 150-154). The hinge includes a hollow sleeve 150, a pin 152 that is slid through the hollow sleeve 150, and an elongated aperture 154 through the hinge.

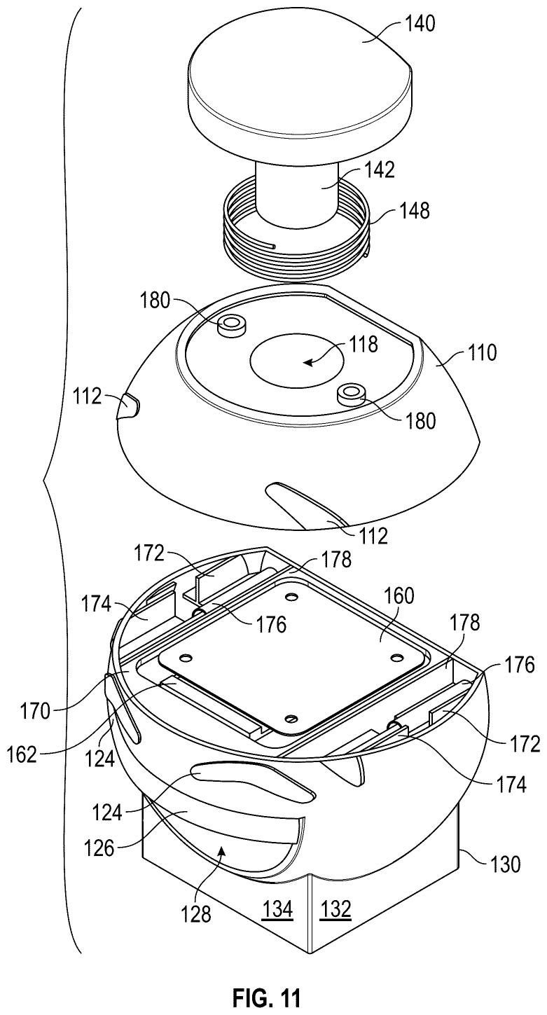

FIGS. 11-14 show internal components 156-178 of the 3D sticker maker 100 in great detail.

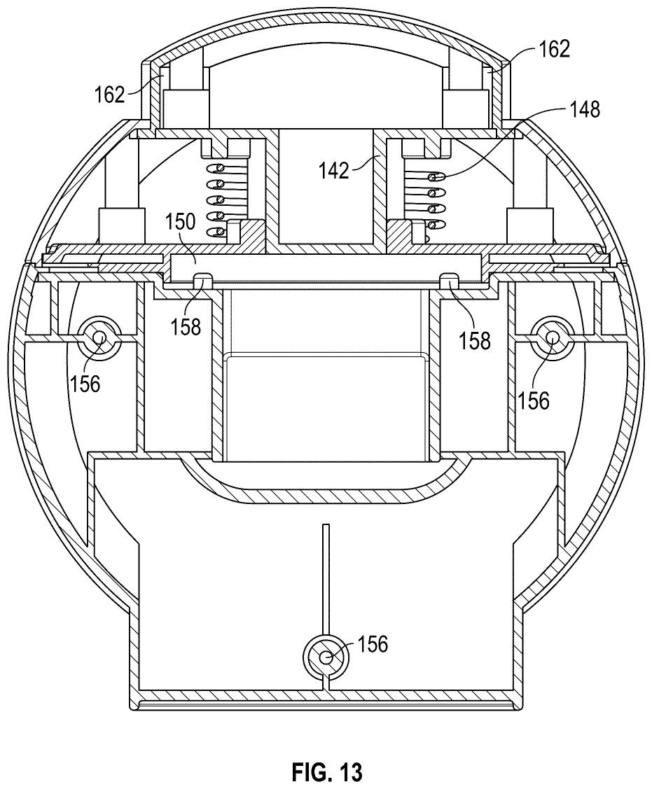

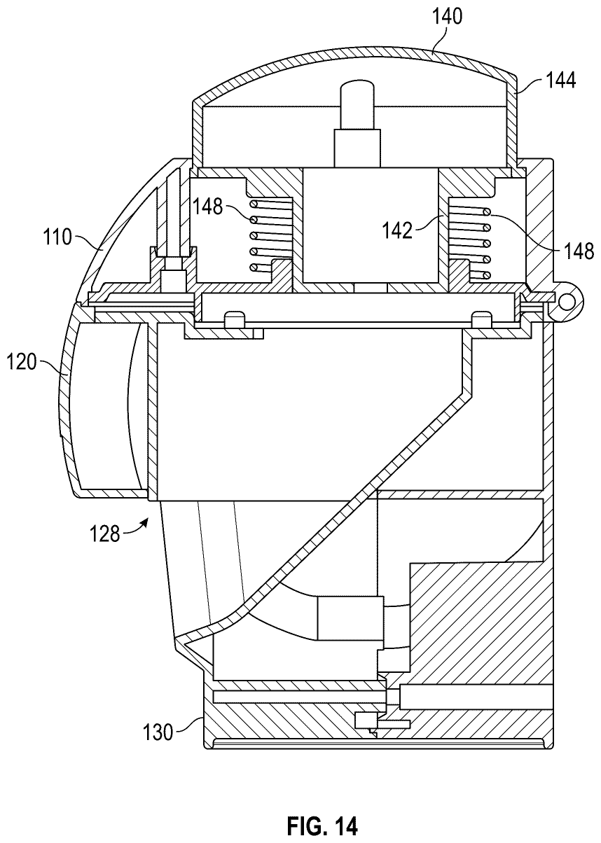

The rear wall 136 has elongated apertures 156 pass almost entirely through the 3D sticker maker 100 (see especially, FIGS. 13-14). FIG. 13 also shows mounting connections 158 for the hinge.

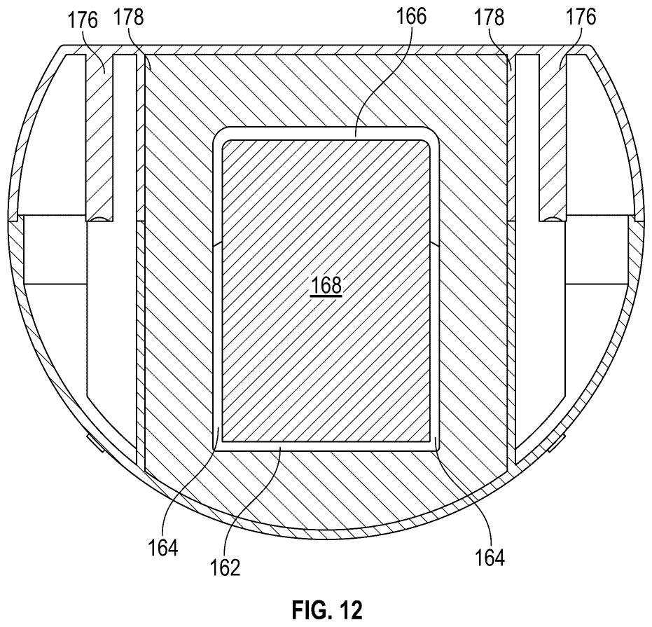

For example, a platform 160 is located just behind a front frame portion 162 and rests on top of side frame portions 164 and a rear frame portion 166 (see e.g. FIG. 12). The platform 160 receives contact from the actuated member 142 when the button 140 is pressed. Optionally, washers or cushions 180 can be included so that an underside of the button 140 is not damaged when pressed repeatedly and/or so that the biasing mechanism 148 is not condensed with such force that it breaks.

The platform 160 is kept in position within the main cavity 168 with a series of support surfaces 170, rear support fins 172, front support fins 174, support pins 176, and support walls 178, all of which are located within the bottom portion 120.

A method of assembling a 3D sticker comprising setting a first side of a sticker into the 3D sticker maker 100; loading a cavity of said first side of the 3D sticker with added mix-ins, sprinkles, glitter, foils, and/or gems; enclosing the cavity with a second side of the 3D sticker such that portions of the first side and the second side adhere to one another; pressing a button 140 on the 3D sticker maker 100 to cut the first side and the second side of the 3D sticker into a desired shape. The 3D sticker can be stuck onto other objects.

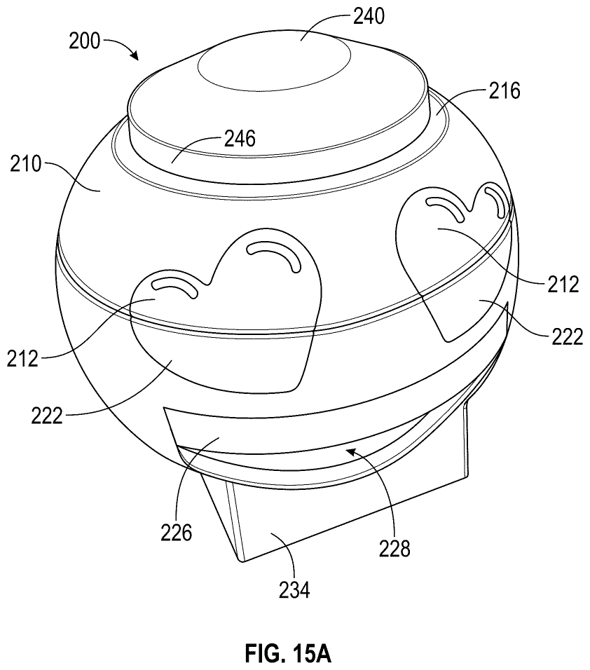

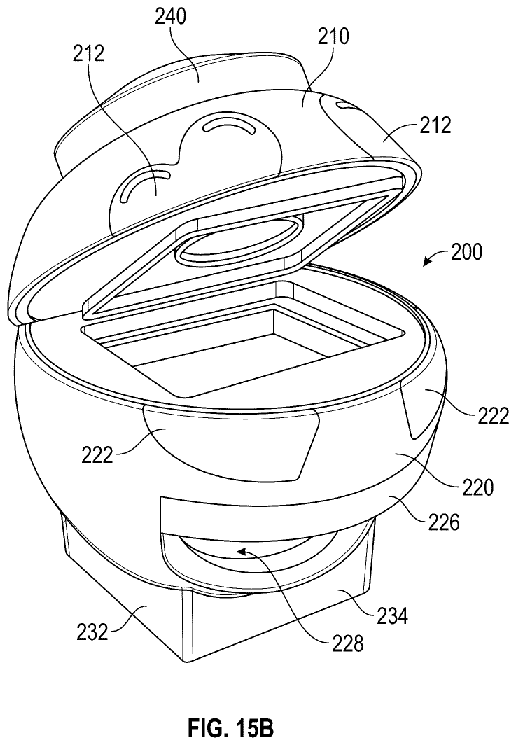

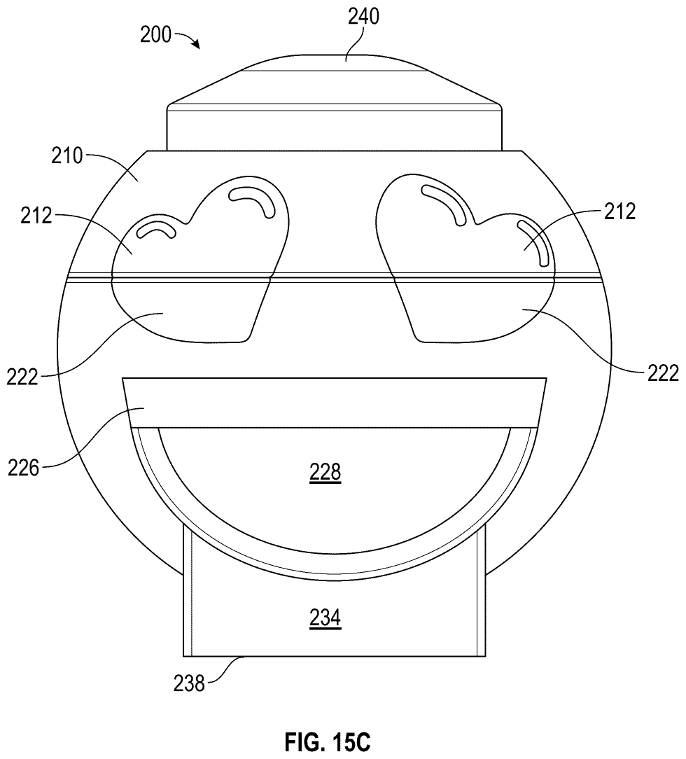

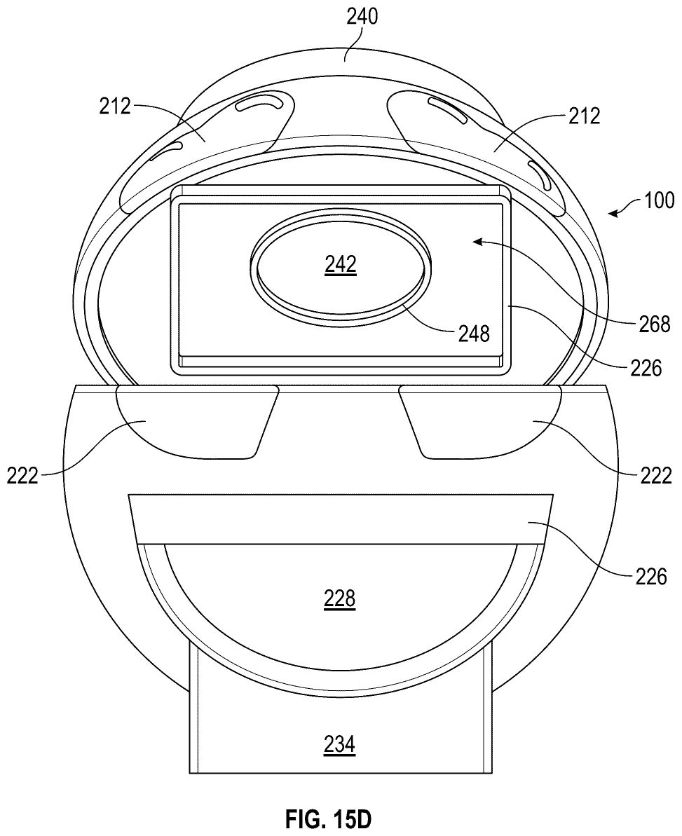

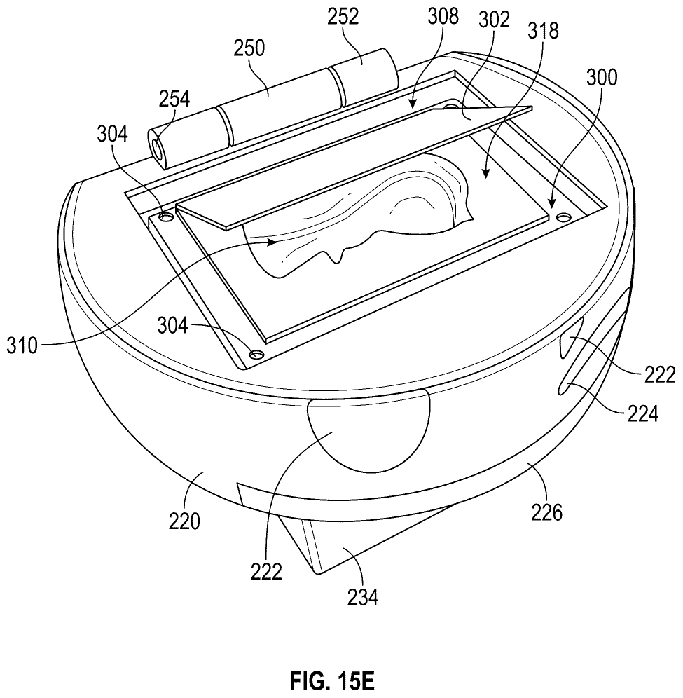

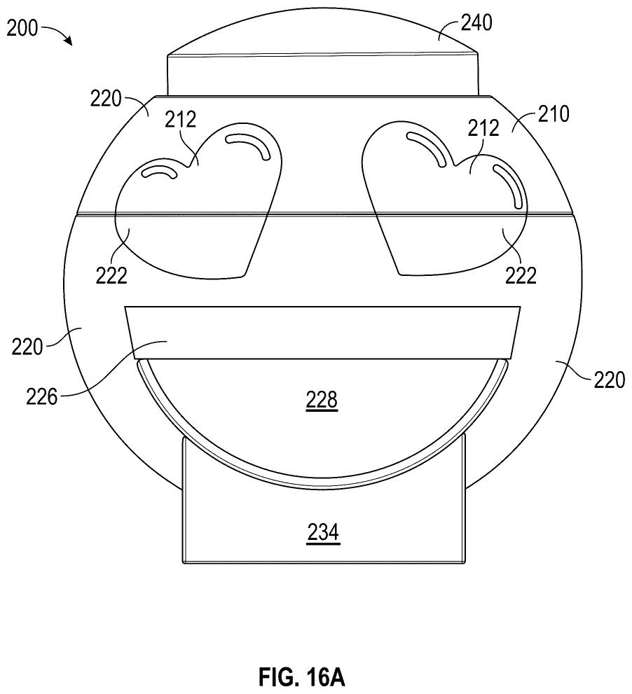

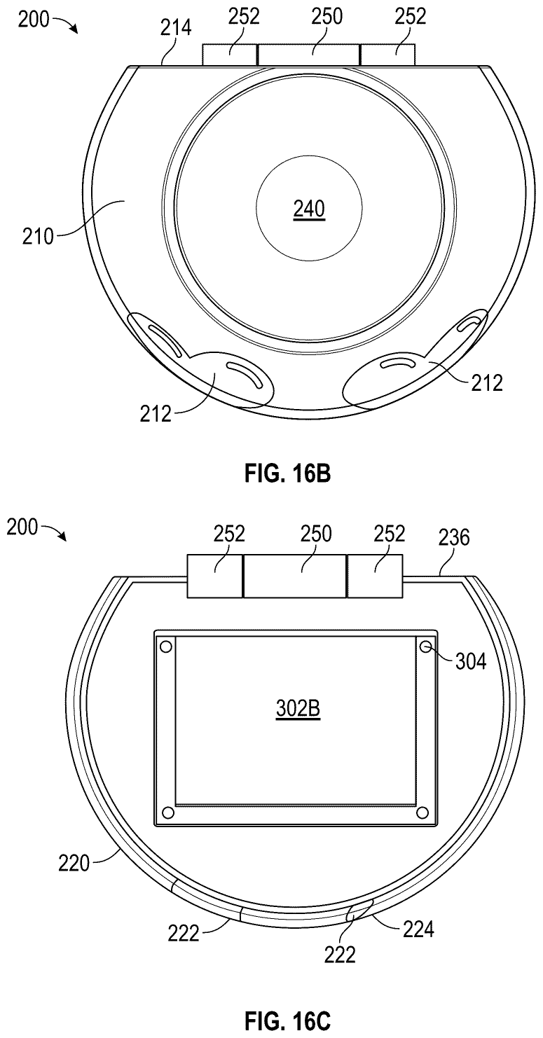

FIGS. 15A-16C show details of a 3D card maker 200. The 3D card maker 200 comprises a top portion 210, a bottom portion 220, a base 230, a button 240, and a hinge (components 250-254). The top portion 210 and the bottom portion 220 are attached by the hinge. The bottom portion 220 and the base 230 are either directly attached to one another or form one integral piece. The button 240 is integrally formed with but is slidable with respect to the top portion 210.

The top portion 210 includes first aesthetic features 212, and the bottom portion 220 includes a second aesthetic features 222. As shown in the non-limiting example of FIGS. 15A-15D and 16A-16C, the first aesthetic features 212 depict upper portions of heart eyes, while the second aesthetic features 222 depict lower portions of eyebrows. In FIG. 15E, third aesthetic features 224 combine with second aesthetic features 222 to help form the winky face emoji. The aesthetic features 212, 222, 224 are designed help improve the overlook look of the 3D card maker 200, to create unique and distinct looks while the 3D card maker 200 is in an open position versus while the 3D card maker 200 is in a closed position. Additionally, the aesthetic features 212, 222, 224 can be dual-purpose in that they can also suggest proper alignment of the top portion 210 and bottom portion 220 while the 3D card maker 200 is in the closed position.

The aesthetic features 212, 222, 224 are shown to be stationary features permanently attached in place to the top portion 210 and bottom portion 220, respectively. However, it is to be appreciated that aesthetic features 212, 222, 224 may be rotatable, translatable, removable, or any combination thereof. The top portion 210 and bottom portion 220 can be configured with several potential mounting points for the aesthetic features 212, 222, 224, to allow the 3D card maker 200 a more customizable look. Not all of the mounting points would have to be utilized at once.

The present disclosure is not limited to just one set of aesthetic features 212, 222, 224 for each of the top and bottom portions 210, 220, respectively. One or more distinct concepts for aesthetic features can be utilized on the top portion 210, the bottom portion 220, or for both portions 210, 220.

For example, in the embodiment shown in FIGS. 15A-16C, the top portion 210 includes only the aesthetic features 212, while the bottom portion includes the aesthetic features 222, 224. As mentioned previously, the top and bottom portions 210, 220 depict portions of eyebrows that can help determine proper alignment amongst same. The bottom portion 220 also includes the aesthetic feature 226 which depicts teeth.

As shown in FIGS. 15A-16C, the top portion 210 includes a rear surface 214. The top portion 210 is analogous to the crown of the head, and the rear surface 214 is analogous to the occiput. The top portion 210 also includes a top surface 216, which in this instance is an annular flange, near where the top portion 210 is in slidable connection with the button 240.

The bottom portion 220 includes an output channel 228 for a 3D card 400. The output channel 228 is depicted as an open mouth.

Kits that include the 3D cards 300 can include over fifty (50) custom refills to create a wide variety of vibrant 3D cards 300, perfect for parties and playdates. Specifically, fifty (50) separate sets of sticker blisters 318, backgrounds 312, and blister trays, plus sprinkles and glitter mix-ins can be included in a single, supplemental kit or they can be included in an initial kit that includes the 3D sticker maker 200. The kits can be themed, such as an undersea theme or a safari theme.

The base 230 takes the shape of a rectangular prism with side walls 232, a front wall 234, a rear wall 236, and a bottom wall 238. The base 230 is designed so that the 3D sticker maker 200 can stand upright while the bottom wall 238 rests on a flat surface, such as a table or a desk. The base 230 has a center of gravity that is located near or right below the center of gravity of the top and bottom portions 210, 220. This allows the base 230 to support the weight of the 3D sticker maker 200 without risk of tipping or toppling. The side walls 232 of the base 230 are located more inwardly than the outwardmost locations of the top and bottom portions 210, 220. The front wall 234 is located behind the output channel 228. The rear wall 236 is shown to be flush with the rear surface 214 of the top portion 210 when the 3D sticker maker 100 is in a closed position.

The button 240 includes a mechanically actuated member 242, which in this instance is a cylindrical shaft. The mechanically actuated member 242 can be actuated through force mechanically applied to the top of the button 240, such as by the push of the human hand, and actuated again through force applied by a biasing mechanism 248, which in this instance is a resilient spring. The button 240 is shaped with a flat, rear surface 244, located more inwardly than the rear surface and wall 214, 236 of the top portion and the base, respectively. A curved surface 246 is approximately concentric with respect to the annular top surface 216 in that the outermost circumference (or, at least, a partial circumference) of the button 240 and inner most circumference (or, at least, a partial circumference) of the top surface 216 are derived from a nearly identical diameter.

As mentioned above, the top portion 210 and the bottom portion 220 establish a hinged connection at the hinge (components 250-254). The hinge includes a hollow sleeve 250, a pin 252 that is slid through the hollow sleeve 250, and an elongated aperture 254 through the hinge.

It is to be appreciated the 3D card maker 200 of FIGS. 15A-16C can utilize the same internal components 156-178 as the 3D sticker maker 100 show throughout FIGS. 11-14.

Examples of artwork used in the figures is non-limiting. For example, while a snowman is shown, the potential artwork to be created could comprise a picture of a giraffe. Ideally, the artwork would inspire a child's imagination and/or encourage the child to use the 3D card maker 200.

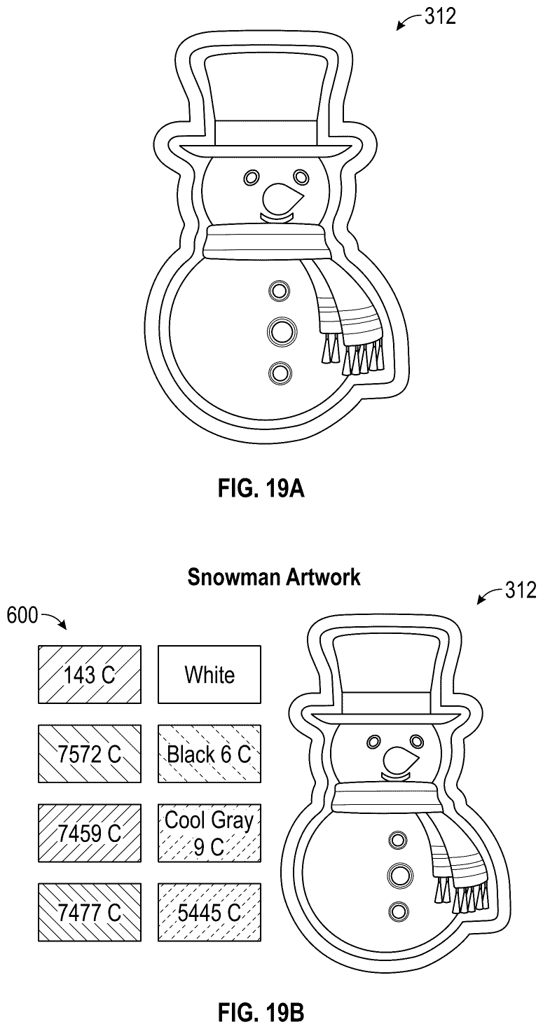

The dimensions shown throughout the drawings are non-limiting unless expressly claimed. In FIG. 16A, it is shown the total height of the 3D card maker 200 can be approximately seven and a quarter inches (7.25″) and the total height can be approximately six and three quarters inches (6.75″). It FIG. 16B, it is shown the total depth of the 3D card maker 200, sans the hinge components 250/252, can be approximately five and one quarter inches (5.25″). In FIG. 16C, it is shown that the total width of the back side 302 and the front side 304 of the 3D card 400 can be approximately three and a half inches (3.5″) and the total height of the 3D card 400 can be approximately two and a half inches (2.5″). Also in FIG. 16C, it is shown that the total width and height of the card holder 300 can be slightly bigger than the back side 302 and the front side 304 of the 3D card 400. For example, the total width of the 3D card holder 300 can be approximately four and one tenth inches (4.1″) and the total height of the 3D card holder 300 can be approximately two and four fifths (4.8″). In FIG. 19A, it is shown the total height of the blister background can be approximately two and three fifths inches (2.6″) and the total width of the blister background 312 can be one and three fifths inches (1.6″). It is preferred that each dimension is within one and a half inches (+/−1.5″) of the values listed above, more preferred that each dimension is within one inch (+/−1″) of the values listed above, and most preferred each dimension is within one half inches (+/−0.5″) of the values listed above.

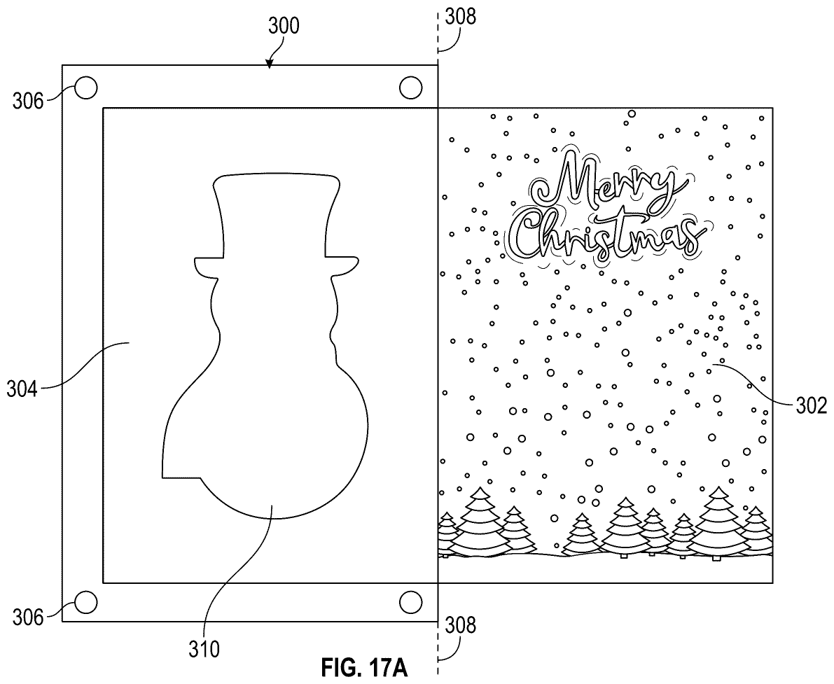

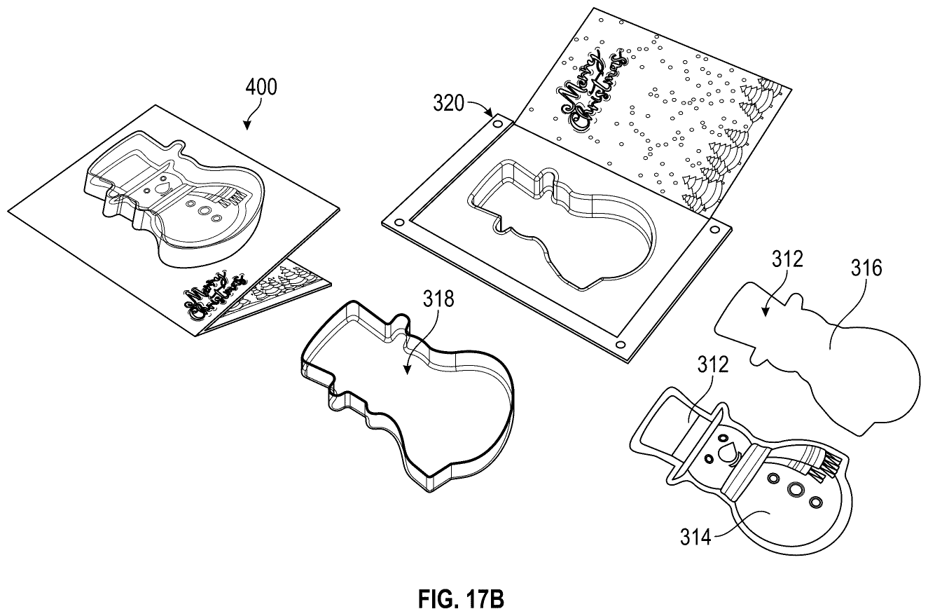

FIGS. 17A-17B show details of a 3D card holder 300 and 3D card 400.

Aspects of the 3D card holder 300 are shown in FIG. 17A. The 3D card holder 300 comprises a right side 302 and a left side 304 with a fold 308 therebetween. Small corner holes 306 exist at each corner of the card holder 300. The 3D card holder 300 features a blister hole 310 that can receive a blister 318.

Aspects of the setup for the blister for the card are shown in FIG. 17B. The blister hole 310, blister background 312, and blister 318 are important components needed to form the three dimensional customizable design of the 3D card 400. The blister background 314 includes a front side 314 and a back side 316, which need not be identical.

The card holder 320 with the blister assembly is also shown.

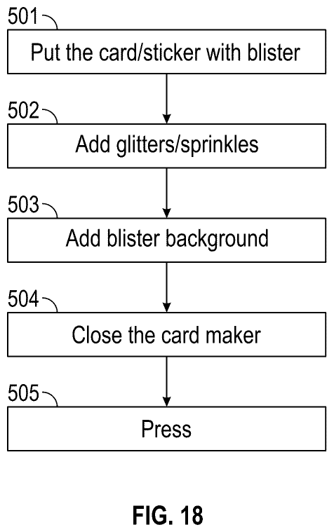

To form the finished 3D sticker or 3D card 400, the method of making the card of FIG. 18 can be followed. A first step 501 of putting the sticker or the card with the blister 318 can be accomplished. Then, a second step 502 of adding glitter, sprinkles, or other visual additives can be accomplished. Then, a third step 503 of adding the blister background 312 can be accomplished. Then, a fourth step 504 of closing the 3D card maker 200 can be accomplished. Then, a fifth step 505 of pressing the button 240 of the 3D card maker 200 completes the method.

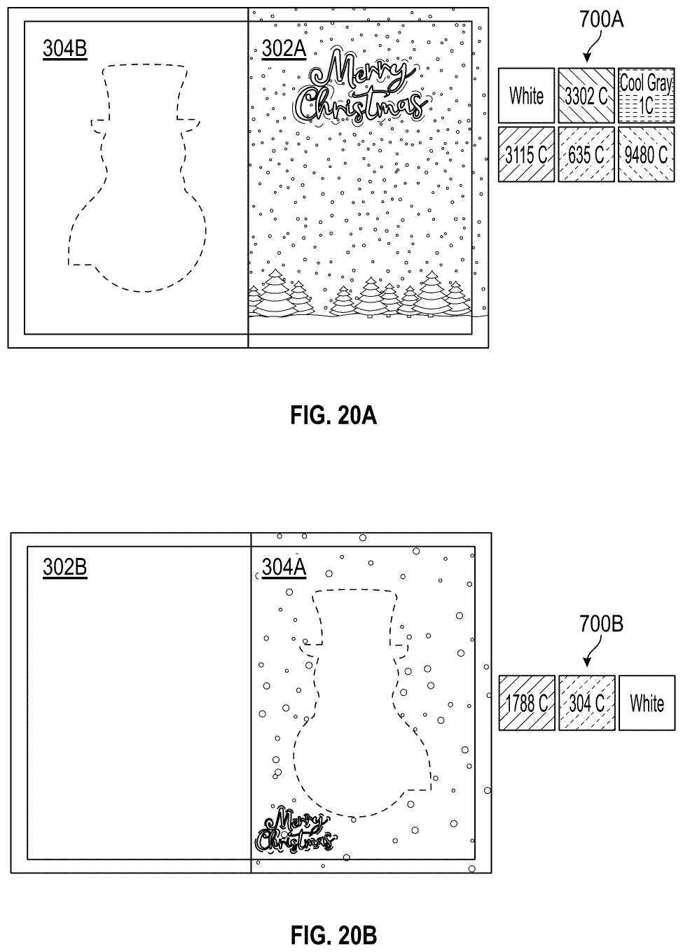

The color schemes shown throughout the drawings are non-limiting unless expressly claimed. The example snowman artwork shown for the front 314 of the blister background 312 in FIG. 19B utilizes example color scheme 600. The color scheme 600, could, for example, comprise Pantone® 000C (white), Pantone® 6 C (black), Pantone® 9 C (cool gray), Pantone® 143 C (yellow), Pantone® 7572 C (orangish-brown), Pantone® 7459 C (light cyan), Pantone® 7477 C (dark cyan). The example card artwork shown in FIGS. 20A and 20B utilizes example inside and outside card color schemes 700A and 700B, respectively. The first color scheme 700A is intended for the inside right side 302A and the inside left-side 304B of the 3D card 400. The second color scheme 700B is intended for the outside right side 302B and the outside left-side 304A of the 3D card 400. The inside and outside card color schemes 700A, 700B ideally complement one another and the color scheme 500 of the artwork. The color scheme 700A for the inside of the 3D card 400 can comprise Pantone® 000C (white), Pantone® 3302 C (very dark cyan), 1 C (cool gray), 3115 C (robin's egg blue), 635 C (sky blue), and 9480 C (very light cyan). The outside card color scheme 700B for the outside of the 3D card 400 can comprise Pantone® 1788 C (pink-red), Pantone® 304 C (icy blue), and Pantone® 000C (white).

Materials used in the production of 3D stickers and 3D cards can vary, with options like acrylic being prevalent due to their durability and clarity. The choice of material often depends on the required features, such as flexibility, adhesion strength, and resistance to environmental factors. These 3D stickers are crafted to withstand the rigors of transportation and handling, ensuring that they remain intact from the manufacturer to the end user.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | 3D sticker maker |
| 110 | top portion (e.g., crown) |
| 112 | first aesthetic feature(s) (e.g., upper portion of an eyebrow, |
| | hair, ears, etc.) |
| 114 | rear surface (e.g. occiput) |
| 116 | top surface (e.g., annular flange) |
| 118 | through hole |
| 120 | bottom portion (e.g., face) |
| 122 | second aesthetic feature(s) (e.g., lower portion of an eyebrow) |
| 124 | third aesthetic feature(s) (e.g., eyes, nose) |
| 126 | fourth aesthetic feature(s) (e.g., lips, teeth) |
| 128 | output channel for 3D sticker (e.g., mouth) |
| 130 | base |
| 132 | side wall |
| 134 | front wall |
| 136 | rear wall |
| 138 | bottom wall |
| 140 | button |
| 142 | mechanically actuated member (e.g., cylindrical shaft) |
| 144 | flat surface |
| 146 | curved surface |
| 148 | spring |
| 150 | sleeve of hinge |
| 152 | pin of hinge |
| 154 | elongated aperture through hinge |
| 156 | elongated apertures through 3D sticker maker |
| 158 | mounting connections for hinge |
| 160 | platform |
| 162 | front frame portion |
| 164 | side frame portion |
| 166 | rear frame portion |
| 168 | main cavity |
| 170 | support surface |
| 172 | rear support fins |
| 174 | front support fins |
| 176 | support pin |
| 178 | support wall |
| 180 | washers/cushions |
| 200 | 3D card maker |
| 210 | top portion |
| 212 | first aesthetic feature (e.g., upper portion of heart eye emojis) |
| 214 | rear surface |
| 216 | top surface (e.g., annular flange) |
| 220 | bottom portion |
| 222 | second aesthetic feature (e.g., lower portion of heart eye emojis, |
| | a first portion of a winky face emoji, etc.) |
| 224 | third aesthetic feature (e.g., eyes) |
| 226 | fourth aesthetic feature (e.g., lips, teeth) |
| 228 | output channel for 3D card |
| 230 | base |
| 232 | side wall |
| 234 | front wall |
| 236 | rear wall |
| 238 | bottom wall |
| 240 | button |
| 242 | mechanically actuated member (e.g., cylindrical shaft) |
| 246 | curved surface |
| 248 | spring |
| 250 | sleeve of hinge |
| 252 | pin of hinge |
| 254 | elongated aperture through hinge |
| 300 | card holder |
| 302 | right side |
| 302A | inside right side |
| 302B | outside right side (back of card) |
| 304A | outside left side (front of card) |
| 304B | inside left side |
| 306 | small corner hole |
| 308 | folds |
| 310 | blister hole |
| 312 | blister background |
| 314 | front of blister background |
| 316 | back of blister background |
| 318 | blister |
| 320 | card with blister assembly |
| 400 | 3D card (finished) |
| 500 | process for creating a 3D card |
| 501 | step: putting the card with blister |
| 502 | step: adding glitters/sprinkles |
| 503 | step: adding blister background |
| 504 | step: closing the card maker |
| 505 | step: pressing |
| 600 | artwork color scheme |
| 700A | inside card color scheme |
| 700B | outside card color scheme |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A kit comprising:
a 3D sticker maker or a 3D card maker;
sticker blisters;
sticker backgrounds;
double-sided sticker adhesives;
a packet selected from the group consisting of: a sprinkle packet and a glitter packet;
gems.

2. The kit of claim 1, wherein there are at least thirty sticker blisters, at least thirty sticker backgrounds, and at least thirty double-sided sticker adhesives.

3. The kit of claim 1, wherein the packet comprises one sprinkle packet and two glitter packets.

4. The kit of claim 1, wherein there are two hundred fifty gems.

5. The kit of claim 1, further comprising instructions for using the 3D sticker maker.

6. A 3D sticker maker comprising:
a top portion hingedly connected to a bottom portion;
a mechanically actuated button that passes through the top portion and can be pressed at an elevation above a top surface of the top portion;
support structure(s) that allow for components of a 3D sticker to be assembled within the 3D sticker maker; and
an output in the bottom portion through which transports 3D stickers that are created as a result of pressing the mechanically actuated button from within the 3D sticker maker to outside the 3D sticker maker.

7. The 3D sticker maker of claim 6, further comprising:
a base with a bottom wall that allows the 3D sticker to stand upright when laid flat on a flat surface.

8. The 3D sticker maker of claim 6, wherein the components are selected from the group consisting of: a sticker blister; a sticker background; a double-sided sticker adhesive; a sprinkle packet; a glitter packet; a gel; a foil; and a gem.

9. A system for making a 3D card comprising:
a 3D card maker;
a card holder;
foldable cards comprising a blister hole;
a blister background comprising distinct sides; and
a blister that can fit into the blister hole.

10. The system of claim 9, further comprising a packet selected from the group consisting of: a sprinkle packet and a glitter packet.

11. The system of claim 10, further comprising gems.

12. The system of claim 11, wherein the blister background comprises a first color scheme.

13. The system of claim 12, wherein the inside of the 3D foldable cards comprises a second color scheme, and the outside of the 3D foldable cards comprises a third color scheme (700B).

14. The system of claim 9, wherein the card holder comprises holes at each corner.

15. The system of claim 9, further comprising instructions for using the 3D card maker.

16. The system of claim 9, wherein the 3D card maker comprises:
a top portion hingedly connected to a bottom portion;
a mechanically actuated button that passes through the top portion and can be pressed at an elevation above a top surface of the top portion;
support structure(s) that allow for components of the 3D card to be assembled within the 3D card maker; and
an output in the bottom portion through which transports 3D cards that are created as a result of pressing the mechanically actuated button from within the 3D card maker to outside the 3D card maker.

17. The system of claim 9, wherein the 3D card maker further comprises a base with a bottom wall that allows the 3D card to stand upright when laid flat on a flat surface.

18. A method of assembling a 3D card using the system of claim 9, the method comprising:
placing a blister background into a blister that is then loaded into a blister hole of a 3D card comprising distinct sides, wherein said 3D card is held in place by a 3D card holder;
putting the assembled combination into a 3D card maker;
pressing a button on the 3D card maker to seal the blister background into the 3D card.

19. The method of claim 18, further comprising folding the 3D card.

20. The method of claim 18, further comprising further loading the blister with added mix-ins, sprinkles, glitter, foils, and/or gems.
